(19) United States
(12) Patent Application Publication
(10) Pub. No.: US 2005/0064002 A1
(43) Pub. Date: Mar. 24, 2005

(54) Termite control agent and method for using termite control agent

(76) Inventors: Koichi Nishimoto, Kyoto (JP); Eisaku Tozaka, Kyoto (JP)

Correspondence Address: BANNER & WITCOFF, 1001 G STREET N W, SUITE 1100, WASHINGTON, DC, 20001, US

(21) Appl. No.: 10/493,963

(22) PCT Filed: Dec. 28, 2001
(86) PCT No.: PCT/JP01/11669

(30) Foreign Application Priority Data
Nov. 9, 2001 (JP) 2001-344754

(51) Int. Cl. A01N 25/00

(52) U.S. Cl. 424/405

(57) ABSTRACT

With attention paid to usefulness of ceramics particles as a carrier, provided are a termite control agent 1 exerting a high repelling effect against a termite obtained by mixing the ceramics particles with another material or other materials, which is made of a mixture of ceramics particles holding a liquid containing hinokitiol in pores of the ceramics particles with powder of calcium borate containing ore, and a method for using a termite control agent 1, in which the termite control agent 1 is mixed into soil S as a portion underlying a base concrete section B of a building.

### TECHNICAL FIELD

The present invention relates to a termite control agent that is a mixture of a residential environment improving material made of ceramics fine particles and calcium borate containing ore powder, and a method for using the same.

### BACKGROUND ART

Termite-caused damage to buildings has been a great problem heretofore. It has been well known that a termite generally likes to eat wet wood, while it has also been known to be a harmful insect being highly omnivorous in such a way as to eat or bore a hole through concrete, the ground, rubber, a kind of plastic as well as cloths and paper in addition to wood. Such a termite-caused damage has been increasingly serious all over the world; irrespective of whether inside or outside Japan and whether in a wet or dry climate. As a measure against termite-caused damage, there has been adopted a method in which synthetic chemicals, natural chemicals and the like are sprayed or coated over places where termites are expected to make nests such as underfloor places of a building, a base concrete structure thereof, soil therearound and the like, whereas in a case where such a method is adopted, an insecticide effect for termites does not last long because of volatility of the chemicals. This requires repetition of a chemical treatment several times at predetermined intervals, having led to a problem of great labor and time and therefore, a lot of cost. Furthermore, there have been a risk that included in the chemicals is an organic compound or organic compounds necessary for precaution in usage because of being harmful to humans, pets and other domestic animals and also a fear that such synthetic chemicals remains in soils or the like. What is worse, an effective component in such a chemical is evaporated and diffused into a room in a house, leading to a health problem related to a sick house syndrome.

There has been conveyed a story that harmful insects such as termites, mites and miscellaneous microbes such as mold are harder to propagate in a building constructed from wood represented by Aomori hiba and Taiwan hinoki. It has been found that a hinikitiol component included in such wood exerts an insecticide effect and an antimicrobial effect. Various kinds of methods have been, therefore, conceived in which an essential oil of hinokitiol or a liquid agent obtained by diluting the essential oil is sprayed or coated directly on underfloor places, base portions and the like of a building to thereby obtain a termite-proof effect. In such a method, however, there has been inconvenience that after a treatment such as spraying of a liquid agent once, an effect at the initial stage of the treatment diminishes as a hinokitiol component in the liquid agent evaporates, which requires repetition of the treatment following the first treatment. In addition, a liquid agent is generally poor in handling since it is stored and transported in a tank or the like.

Under such circumstances, there has been a need for a termite control agent capable of using hinokitiol harmless to humans, animals and environments effectively, and of sustaining a termite repelling effect exerted by hinokitiol for a long term.

The present invention, in light of the above problem, is a product capable of exerting a high repelling effect on termites obtained by paying attention to porous ceramics particles as a carrier of hinokitiol to mix the particles with another or other material.

### DISCLOSURE OF THE INVENTION

A termite control agent of the present invention is characterized by that the agent is obtained by mixing ceramics particles holding a liquid containing hinokitiol or hiba oil in pores thereof with powder of calcium borate containing ore.

It has been known that a ceramics particle is generally porous and has a property to adsorb various kinds of materials irrespective of whether a water-soluble material or an oil-soluble material in pores therein. Such an action of ceramics as a carrier is given attention thereto and a liquid containing hinokitiol is held in pores thereof, whereby especially a termite repelling effect can be attained for a long term since adsorbed hinokitiol is gradually evaporated from the pores. Herein, as hiokitiol, there can be used liquid agents extracted from Aomori hiba, Taiwan hinoki or the like, or a solution of chemically synthesized hinokitiol. Alternatively, hiba oil can also be held in pores of ceramics particles in order to obtain an effect of hinokitiol in a simpler way. In such a context, since much of hinokitiol is contained in hiba oil, so not only can the effects such as an antimicrobial effect, an mold-proof effect and an insecticide effect be obtained but a hinokitiol extraction process from hiba oil is not necessary either, reduction can be realized in cost and time related to fabrication of such ceramics particles. Furthermore, by using the ceramics particles together with calcium borate containing ore having a termite repelling effect, for example colemanite, a long lasting, high termite control effect can be expected in combination with an effect of hinokitiol held by and continuously released from the ceramics particles. Note that ceramics particles employed in the present invention are artificial ceramics particles containing high purity ceramics as a main component.

An especially preferable ratio in content of the ceramics particles to the powder of calcium borate containing ore is in the range of from 1 to 9 to 5 to 5 and a proper mixing ratio has only to be selected in consideration of a relationship of a cost versus an effect. Note that the above ratio can be altered outside the range so as to be adapted for a site where a such a termite control agent is applied.

Such a termite control agent can be incorporated into predetermined soil by an easy work, and as a method for using the termite control agent with a sufficient termite proof effect, exemplified is a method in which the termite control agent is mixed into soil as a portion supporting a base concrete section of a building prior to deposition of the base concrete section.

### BRIEF DESCRIPTION OF THE DRAWINGS

FIG. 1 is a sectional view of ceramics particles used in an embodiment of the present invention.

FIG. 2 is a descriptive view showing a termite proof effect test method for ceramics particles used in the embodiment.

FIGS. 3(a) and 3(b) are tables showing details and results of a termite proof effect test.

FIG. 4 is a schematic sectional view showing a example use of the embodiment.

### BEST MODE FOR CARRYING OUT THE INVENTION

Description will be given of the present invention based on the embodiment shown in the accompanying drawings.

A termite control agent 1 in the embodiment is a mixture composed of ceramics particles 11 described later and calcium borate containing ore powder (hereinafter referred to as “colemanite” not shown) combined as main component.

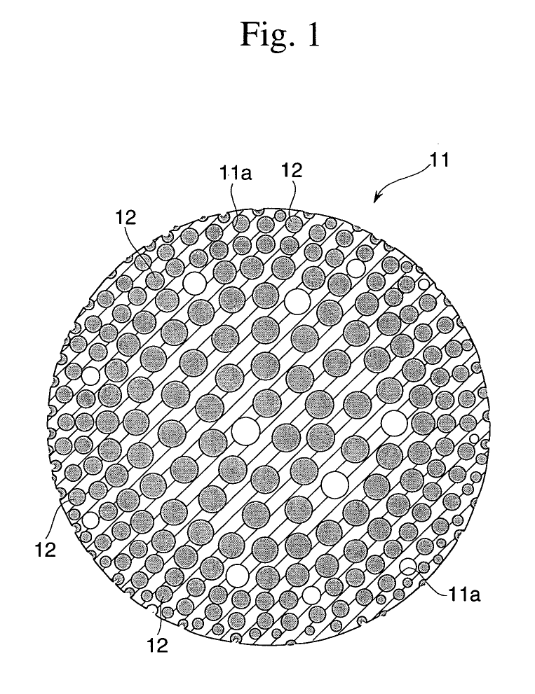

The ceramics particles 11, as shown as a model in FIG. 1, contains hiba oil 12 in pores 11a thereof. The ceramics particles 11, as shown in the figure, have sizes of about 7 μm in average particle diameter and an individual particle is an ultra porous fine particle with innumerable fine pores 11a therein. The ceramics particles 11 in a predetermined amount are put into a vessel containing, for example, hiba oil 12 and after the hiba oil 12 is adsorbed into the pores 11a, the particles 11 are dried up to a level at which the hiba oil 12 is not evaporated to fabricate products. The hiba oil 12 is an oil-soluble component containing much of hinokitiol from a liquid produced by exposing small pieces obtained by crushing wood chips, barks and branches and leaves of Aomori hiba or Taiwan hinoki to steam at high temperature under high pressure. Note that a fabrication method for ceramics particles 11 may be a method in which used is a mixed liquid obtained by diluting the hiba oil 12 with alcohol in advance to thereby reduce a viscosity of the hiba oil 12 for the purpose to raise an adsorption efficiency of the hiba oil 12 into the pores 11a. To be concrete, hiba oil 12 is diluted with alcohol such as edible ethanol to form a mixed liquid and the ceramics particles 11 are put into the mixed liquid to thereby cause the particles 11 to adsorb the liquid, followed by removal of the excessive mixed liquid in filtration and by removal of the alcohol from the mixed liquid adsorbed into the pores 11a in natural drying or hot air drying.

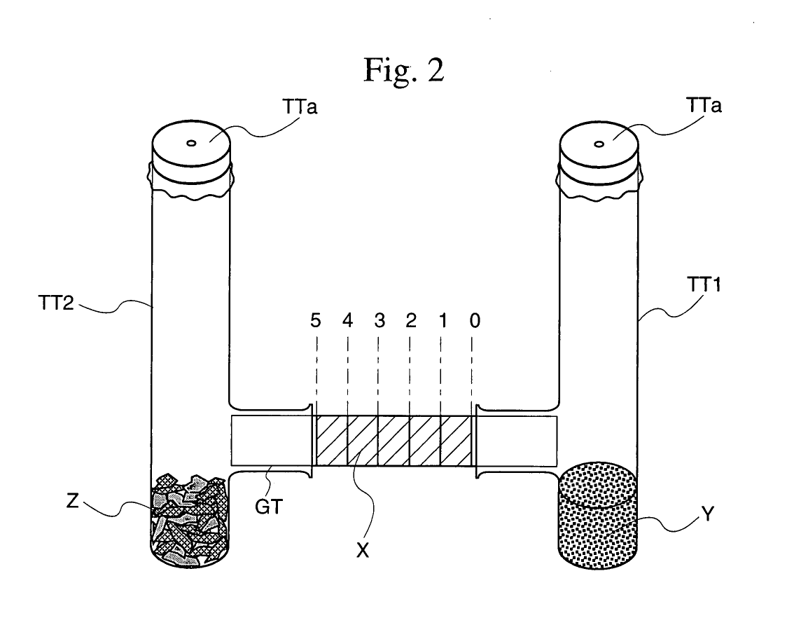

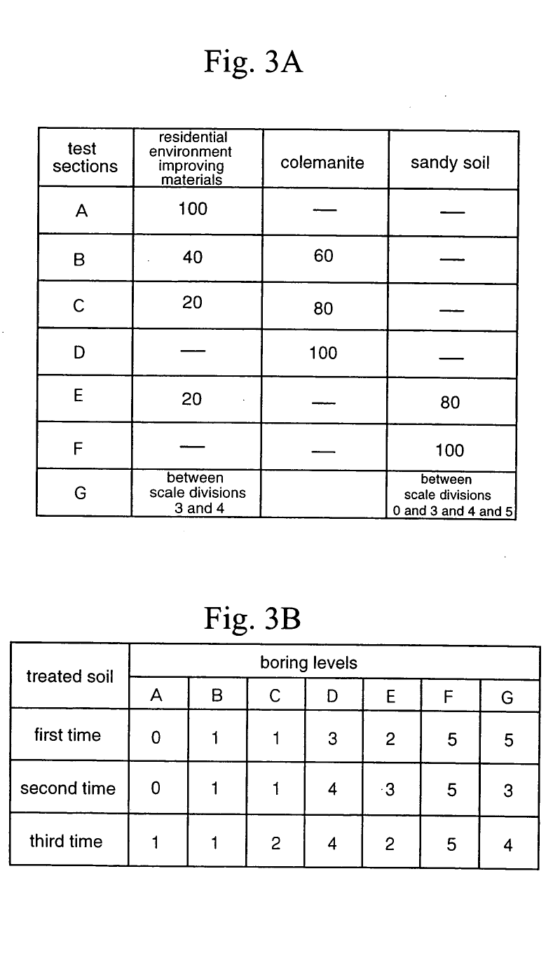

Description will be given herein of a termite proof effect test on the ceramics particles 11 and results of the test with reference to FIG. 2 and FIGS. 3(a) and 3(b). The test is in conformity with “Ant-proof Efficacy Test Method for Ant-proof Agent for Soil Treatment and Indoor Test Method by Performance Standard (1), Japan Wood Preservation Association Standard No. 13 (1992). Brief description will be given of the test method. As shown in FIG. 2, two test glass tubes TT1 and TT2 each with a branch are positioned so as to cause the respective branches to face each other and a glass tube GT open at both ends is inserted into the respective branches. The glass tube GT is filled with a specimen X and scale divisions are sequentially marked with 0 to 5 at an equal spacing of about 1 cm starting from one side (the right side in the figure) in one length direction. On the other hand, a predetermined number of termites (not shown) together with non-treated soil Y are put in the test tube TT1 (on the right side in the figure), while put in the other test tube TT2 (on the left side) is crushed chips Z of red pine, which is a bait for termites. Aluminum foils TTa each with a hole cover the top ends of the respective both tubes. That is, the test is to investigate as far as what scale division a termite can advance into the specimen X in order to eat crushed chips Z of red pines in the test tube TT1 after a predetermined time elapses at a predetermined temperature.

Herein, as the specimens X in the test, 7 test sections A to G are set and the test is repeated three times in each test section. In FIG. 3(a), there are shown details of a specimen X in each test division. To be concrete, each specimen X is put in the glass tube GT in a uniform mixture if the specimen is in a mixture, wherein 100% of the ceramics particles 11 are included in the test division A, 40% of the ceramics particles 11 and 60% of colemanite are included in the test division B, 20% of the ceramics particles 11 and 80% of colemanite are included in the test division C, 100% of colemanite is included in the test division D, 20% of the ceramics particles 11 and 80% of sandy soil are included in the test division E, and 100% of sandy soil is included in the test division F. In the test division G, the ceramics particles 11 fill only between scale division 3 and 4 and the sandy soil fill between scale divisions 0 and 3 and between scale divisions 4 and 5.

Results of the test are shown in FIG. 3(b). In the figure, numerical values indicate boring levels and with a smaller value thereof, it shows that an ant-proof effect is higher. That is, in the test division A where the ceramics particles 11 included in content of 100%, an extremely high ant-proof effect was obtained. In the test divisions B, C and E including 40% or 20% of the ceramics particles as well, a high ant-proof effect was able to be obtained irrespectively whether the other component of the ceramics particles 11 is colemanite or sandy soil. The ceramics particles 11 mixed with colemanite, to be more exact, was higher in a termite-proof effect than mixed with sandy soil. It is said that a termite-proof effect of the test sections D, F in which colemanite or sandy sand alone was used was low or almost nothing. Furthermore, it was found that since a termite-proof effect in the test division G was low, a uniform mixture of sandy soil and the ceramics particles 11 (the test section E) obtained a higher termite-proof effect than the ceramics particles 11 disposed as a 100% local region in a test division with the. other regions of sandy soil.

From the above description, it was found that a mixture of the ceramics particles 11 with another material, especially colemanite, in a proper proportion exerts a good termite-proof effect.

The termite control agent 1 containing a mixture of such ceramics particles 11 with colemanite as a main component is a mixture of 2 wt % of the ceramics particles 11 and 8 wt % of collemanite taking into consideration the results of the above test. This mixing proportions, as described above, correspond to the test division C in which an extremely high termite-repelling effect was attained. Since especially, the ceramics particles 11 and colemanite powder are solid, storage and transportation are easy and excellent in handlability.

Then, description will be given of a method for using the termite control agent in the embodiment.

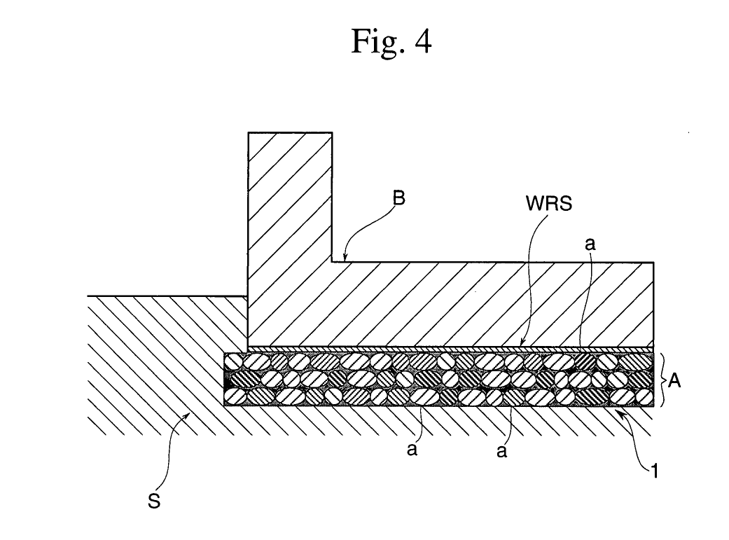

On construction sites, as shown in FIG. 4, before a base concrete section B of a building is deposited, soil S at a portion supporting the base concrete section B from below is removed while being combed, a predetermined amount of cobble stones a are spread on the top surface of the soil S underlying the base concrete section B to form a cobble stone layer A and thereafter the termite control agent 1 is caused to flow into the cobble stone layer A almost as high as the top surface thereof, which is followed by application of a pressure from above, thereby forming a layer of the termite control agent 1. Thereafter, the base concrete section B is deposited on the layer of the termite control agent 1 with a moisture-proof sheet WRS interposed therebetween. With such an extremely simple work done, not only can the termite control agent 1 be mixed into soil S at a predetermined site, but effects described below are also exerted.

That is, if the termite control agent 1, when being used, is mixed into the soils S or sprayed on the soil S, hiba oil 12 at first evaporates from the pores 11a of the ceramics particles 11, a termite-proof effect and the like is exerted in the soil S by the action of hinokitiol contained in hiba oil 12 and termite-caused damage can be prevented continuously over middle and long terms starting at the initial stage of construction. Furthermore, the termite control agent 1 exerts an extremely excellent termite-proof effect in the cooperative action of such an effect of hinokitiol and a termite repelling effect that colemanite posses inherently. Moreover, the effect obtained by released hinokitiol works as not only a termite-proof effect, but also an insecticide effect against harmful insects including mites and others, and a microbicidal effect and an antimicrobial effect against mold, bacteria and others.

Note that by mixing the termite control agent 1 and cement powder with water at proper proportions to cause the mixture to flow over the cobble stones layer A laid down in the soil S to a small thickness on the layer to thereby achieve the supporting portion underlying the base concrete section B, a termite repelling effect almost as excellent as as described above can also be sufficiently exerted. Proportions of the ceramics particles 11 and colemanite can also be altered to proper values within the range in which a termite-proof effect is not greatly degraded while a relationship of a cost versus an effect being considered.

The others being considered, concrete constructions of each of the elements are not limited to the embodiments and various alterations or modifications can be implemented without departing the spirit and scope of the present invention.

Industrial Applicability

The present invention, as detailed above, is a novel termite control agent made of a mixture composed from ceramics particles holding hiba oil or a liquid containing hinokitiol in pores thereof and calcium borate containing ore powder. Accordingly, by using calcium borate containing ore powder and ceramics particles combined each alone not exerting a high effect continuoustly, a long lasting, high termite control effect can be expected in cooperation with an effect of hinokitiol held in the ceramics particles and released continuously. With an extremely simple work that such a termite control agent is mixed into soil serving as supporting portion underlying a base concrete section of a building before the base concrete section is deposited, a high termite repelling effect is exerted.

1. A termite control agent comprising a mixture of ceramics particles holding a liquid containing hinokitiol or hiba oil in pores of the ceramics particles with powder of calcium borate containing ore combined as a main component.

2. The termite control agent according to claim 1, wherein a ratio in content of the ceramics particles to the powder of calcium borate containing ore is in the range of from 1 to 9 to 5 to 5.

3. A method for using a termite control agent, in which the termite control agent according to claim 1 is mixed into soil as a portion supporting a base concrete section of a building prior to deposition of the base concrete section.

4. A method for using a termite control agent, in which the termite control agent according to claim 2 is mixed into soil as a portion supporting a base concrete section of a building prior to deposition of the base concrete section.
